(19) United States
(12) Patent Application Publication
(10) Pub. No.: US 2024/0059599 A1
(43) Pub. Date: Feb. 22, 2024

(54) MOLD FOR MOLDING GLASS PRODUCT

(71) Applicant: AAC Optics (Chongqing) Co., Ltd., Chongqing (CN)

(72) Inventors: Linzhi Zhao, Shenzhen (CN); Jian Wang, Shenzhen (CN)

(21) Appl. No.: 18/088,639

(22) Filed: Dec. 26, 2022

Related U.S. Application Data
(63) Continuation of application No. PCT/CN2022/119109, filed on Sep. 15, 2022.

(30) Foreign Application Priority Data
Aug. 22, 2022 (CN) 202222209059.4

(51) Int. Cl. C03B 11/08

(52) U.S. Cl. CPC C03B 11/084; C03B 11/088

(57) ABSTRACT

A mold for molding a glass product is provided. The mold includes a first pressing mold having a first surface and a second pressing mold having a second surface. The first surface is located on a side of the first pressing mold. The second surface is located on a side of the second pressing mold. The first pressing mold includes a first molding portion formed by bending from the first surface. The second pressing mold includes a second molding portion and is formed by bending from the second surface. The first pressing mold further includes a plurality of first hydraulic resistance portions that are spaced apart from each other, close to an outer edge of the first pressing mold, and protrude from the first surface. The disclosure achieves a technical effect of increasing a peripheral molding pressure of the mold and improving yield of products.

### CROSS REFERENCE TO RELATED APPLICATIONS

The present application is a continuation of PCT Patent Application No. PCT/CN2022/119109, filed Sep. 15, 2022, which claims priority to Chinese patent application No. 202222209059.4, filed Aug. 22, 2022, each of which is incorporated by reference herein in its entirety.

### TECHNICAL FIELD

The disclosure relates to the field of lens technologies, in particular, to a mold for molding a glass product.

### BACKGROUND

As apertures of cameras in mobile phones are getting larger, sizes of the cameras are getting smaller, and the mobile phones are becoming lighter, higher requirements are put forward for the lenses. Performance of traditional plastic lenses is hard to be improved further, while glass lenses can be further improved to break bottlenecks that current mobile phone lenses face.

At present, in existing optical technologies, the lens is made through thermoforming by using a glass processing mold. After the glass processing mold is closed, a mold body may define a space having a preset shape. The space is used to define a shape of a glass material being heated, to lead to forming a glass product. A formed glass product may be cut into separate lenses in a corresponding region to form a plurality of lenses. However, there is not sufficient molding pressure on a periphery of the mold during manufacturing, and thus the molding pressure at the center and periphery may be unbalanced. In addition, it is easy to result in poor molded appearance where a periphery of a lens is foggy or there is a bubble in the periphery of the lens, and poor yield of products during manufacturing.

As such, in current lens technology, insufficient peripheral molding pressure of the mold and poor yield of the products are existed.

### SUMMARY

The disclosure aims to solve technical problems of insufficient peripheral molding pressure of a mold and poor yield of lens products.

To address technical problems described above, the disclosure provides a mold for molding a glass product. The mold includes a first pressing mold having a first surface and a second pressing mold having a second surface. The first surface is located on a side of the first pressing mold close to the second pressing mold. The second surface is located on a side of the second pressing mold close to the first pressing mold. The first pressing mold includes a first molding portion for molding the glass product. The first molding portion is formed by bending from the first surface. The second pressing mold includes a second molding portion corresponding to the first molding portion. The second molding portion is formed by bending from the second surface. The first pressing mold further includes a plurality of first hydraulic resistance portions spaced apart from each other. The first hydraulic resistance portions are close to an outer edge of the first pressing mold, and protrude towards the second pressing mold from the first surface.

Further, the second pressing mold further includes a plurality of second hydraulic resistance portions spaced apart from each other, and the plurality of second hydraulic resistance portions are provided corresponding to the plurality of first hydraulic resistance portions.

Further, the plurality of second hydraulic resistance portions protrude towards the first pressing mold from the second surface.

Further, the plurality of second hydraulic resistance portions are recessed in the second surface in a direction away from the first pressing mold. A size of each of the first hydraulic resistance portions protruding from the first surface is greater than a size of a corresponding second hydraulic resistance portion of the second hydraulic resistance portions recessed in the second surface.

Further, in a direction perpendicular to the first surface, a junction of each of the plurality of first hydraulic resistance portions and the first surface has a circular shape or a fan-ring shape.

Further, there are an even number of first hydraulic resistance portions, and the even number of first hydraulic resistance portions are provided around a center of the first surface.

Further, in a direction perpendicular to the second surface, a junction of each of the plurality of second hydraulic resistance portions and the second surface has a circular shape or a fan-ring shape.

Further, there are an even number of second hydraulic resistance portions, and the even number of second hydraulic resistance portions are provided around a center of the second surface.

Further, a number of the plurality of first hydraulic resistance portions is the same as a number of the plurality of second hydraulic resistance portions.

Further, each two adjacent second hydraulic resistance portions of the plurality of second hydraulic resistance portions have an equal distance therebetween.

Further, the second hydraulic resistance portions are substantially flush with the second surface.

Further, a central point of the plurality of second hydraulic resistance portions is the same as a center of the second surface.

Further, a central point of the plurality of first hydraulic resistance portions is the same as a center of the first surface.

Further, each two adjacent first hydraulic resistance portions have an equal distance therebetween.

The embodiments of the disclosure have following advantageous effects.

In the mold for molding a glass product, the first surface is located on the side of the first pressing mold close to the second pressing mold and the second surface is located on the side of the second pressing mold close to the first pressing mold. The first molding portion for molding the glass product in the first pressing mold is formed by bending from the first surface. The second molding portion in the second pressing mold corresponds to the first molding portion. The second molding portion is formed by bending from the second surface. The plurality of first hydraulic resistance portions are provided in the first pressing mold and spaced apart from each other. The first hydraulic resistance portions are close to the outer edge of the first pressing mold, and protrude towards the second pressing mold from the first surface. In this way, by providing the plurality of first hydraulic resistance portions outside the cavity regions of the first molding portion and the second molding portion, a wafer may be prevented from flowing toward external directions of the cavity regions, so as to balance molding pressures inside and outside the cavity regions. Therefore, molding pressures outside the cavity regions during manufacturing of lenses can be increased, thereby increasing a peripheral molding pressure of the mold. As such, molding pressures inside and outside the cavity region are balanced, which is advantageous for improving yield of products. Therefore, technical effects of increasing a molding pressure outside the cavity region, and improving yield of the products can be achieved.

### BRIEF DESCRIPTION OF DRAWINGS

In order to illustrate the technical solutions in the embodiments of the disclosure or in the existing technologies more clearly, the drawings used in the description of the embodiments will be briefly described below. It is obvious that the drawings in the following description are only some embodiments of the disclosure. For those skilled in the art, other drawings may also be obtained in accordance with the drawings without any inventive effort.

FIG. 1 is a schematic view of a mold for molding a glass product according to according to embodiments of the disclosure.

FIG. 2 is a schematic view of a mold for molding a glass product according to other embodiments of the disclosure.

FIG. 3 is a first schematic view of a first hydraulic resistance portion and a second hydraulic resistance in a mold for molding a glass product according to embodiments of the disclosure.

FIG. 4 is a second schematic view of the first hydraulic resistance portion and the second hydraulic resistance in the mold for molding a glass product according to other embodiments of the disclosure.

FIG. 5 is a third schematic view of the first hydraulic resistance portion and the second hydraulic resistance in the mold for molding a glass product according to other embodiments of the disclosure.

FIG. 6 is a schematic structural view of a mold for molding a glass product according to embodiments of the disclosure.

### DETAILED DESCRIPTION OF EMBODIMENTS

The disclosure discloses a mold for molding a glass product. A first surface 11 is located on a side of a first pressing mold 1 close to a second pressing mold 2. A second surface 21 is located on a side of the second pressing mold 2 close to the first pressing mold 1. A first molding portion 12 for molding the glass product in the first pressing mold 1 is formed by bending from the first surface 11. A second molding portion 22 in the second pressing mold 2 corresponds to the first molding portion 12. The second molding portion 22 is formed by bending from the second surface 21. A plurality of first hydraulic resistance portions 13 are provided at intervals in the first pressing mold 1. The first hydraulic resistance portions 13 are close to an outer edge of the first pressing mold 1, and protrude towards the second pressing mold 2 from the first surface 11. In this way, by providing the plurality of first hydraulic resistance portions 13 outside cavity regions of the first molding portion 12 and the second molding portion 22, a wafer may be prevented from flowing toward external directions of the cavity regions, so as to balance molding pressures inside and outside the cavity regions. Therefore, molding pressures outside the cavity regions during manufacturing of lenses can be increased, thereby increasing a peripheral molding pressure of the mold. As such, molding pressures inside and outside the cavity region are balanced, which is advantageous for improving yield of products. Therefore, technical effects of increasing a molding pressure outside the cavity region, balance of molding pressures inside and outside the cavity region, and improving yield of the products can be achieved.

Technical solutions in embodiments of the disclosure may be described with reference to the drawings for the embodiments of the disclosure more clearly and completely. Obviously, the embodiments described are only some embodiments rather than all embodiments of the disclosure. On the basis of the embodiments of the disclosure, all the other embodiments obtained by those skilled in the art fall into the scope of the disclosure. The key term of “and/or” in the disclosure presents two conditions, “and” and “or”. That is, the expression “A and/or B” disclosed in the disclosure represents two conditions “A and B” and “A or B”. The expression “A and/or B” describes three status: only A is included, only B is included, and both A and B are included.

It would be appreciated that although terms “first”, “second” and the like herein may be used to describe different elements, components, regions, layers, and/or portions, these elements, components, regions, layers, and/or portions should not be limited by these terms. The terms are only used for distinguish one element, component, region, layer, or portion from another element, component, region, layer, or portion. Therefore, without departing from the teaching of the exemplary embodiments, a first element, component, region, layer, or portion described in the following may be also called as a second element, component, region, layer, or portion. Herein, space terms such as “lower” and “upper” may be used, in order to describe a relationship between one element or feature and another element or feature. It may be appreciated that besides the locations shown in the drawings, space terms further include directions of devices during use or operation. For example, if a device in the drawings is reverted, an element or feature referred to as “lower” would be taken as “upper” element or feature. Therefore, the exemplary term “lower” may include the upper and lower directions. The device may be relocated (be rotated by 90 degrees or in another direction), and a reference sign for space description may be described accordingly.

In addition, in the disclosure, if a component is considered to be “fixed to” another component, the component may be directly disposed on the another component or there may be a middle component between them. If a component is considered to be “connected” to another component, the component may be directly connected to the another component or there may be a middle component between them. If a component is considered to be “provided on” another component, the component may be directly provided on the another component or there may be a middle component between them. Terms such as “vertical”, “horizontal”, “left”, “right” used in the embodiments in the disclosure are merely intended to describe the disclosure rather than limit the disclosure.

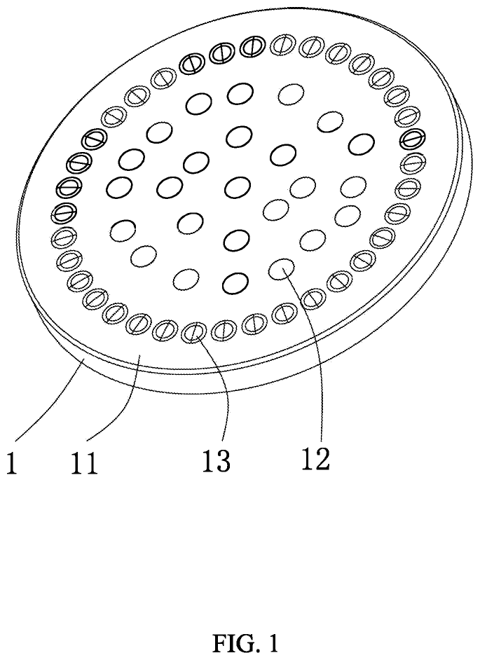

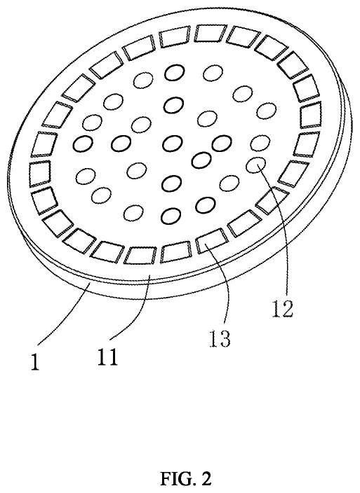

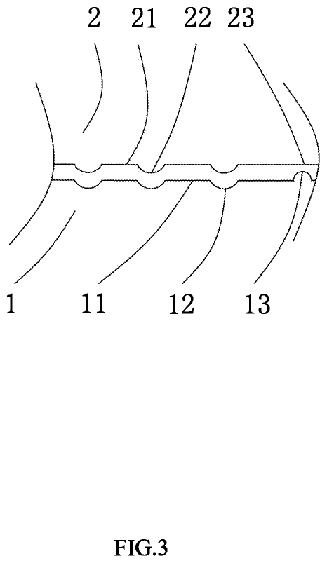

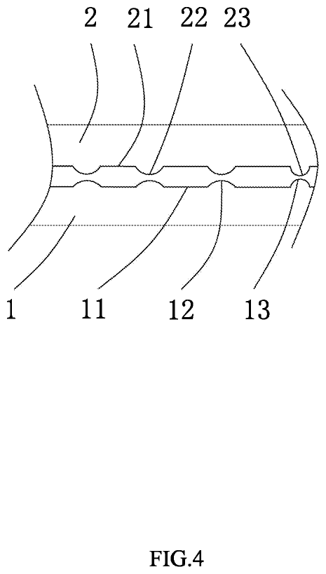

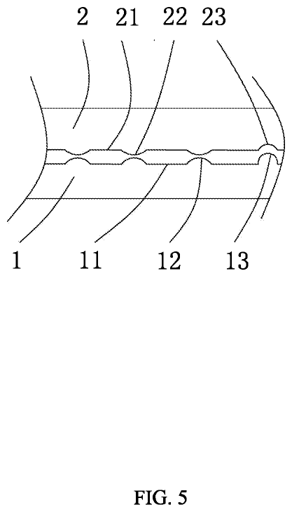

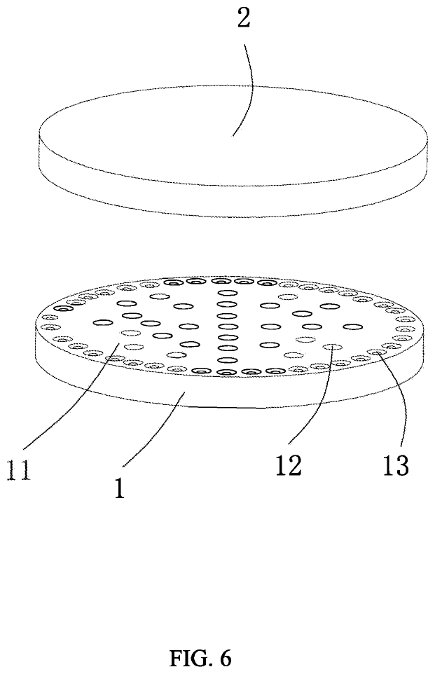

With reference to FIG. 1 and FIG. 2, FIG. 1 is a schematic view of a mold for molding a glass product according to according to embodiments of the disclosure. FIG. 2 is a schematic view of a mold for molding a glass product according to other embodiments of the disclosure. FIG. 3 is a first schematic view of a first hydraulic resistance portion 13 and a second hydraulic resistance 23 in a mold for molding a glass product according to embodiments of the disclosure. FIG. 4 is a second schematic view of the first hydraulic resistance portion 13 and the second hydraulic resistance 23 in the mold for molding a glass product according to other embodiments of the disclosure. FIG. 5 is a third schematic view of the first hydraulic resistance portion 13 and the second hydraulic resistance 23 in the mold for molding a glass product according to other embodiments of the disclosure. FIG. 6 is a structural diagram of a mold for molding a glass product according to embodiments of the disclosure. The disclosure discloses a mold for molding a glass product. The mold for molding a glass product is specifically described as follows.

The first pressing mold 1 having the first surface 11 and the second pressing mold 2 having the second surface 21 are described as follows.

The first surface 11 is located on the side of the first pressing mold 1 close to the second pressing mold 2. The second surface 21 is located om the side of the second pressing mold 2 close to the first pressing mold 1. The first pressing mold 1 includes the first molding portion 12 for molding a glass product. The first molding portion 12 is formed by bending from the first surface 11. For example, the first molding portion 12 is formed by forming a concave shape on the first surface 11 by bending the first surface 11 in a direction away from the second surface 21, or by forming a convex shape on the first surface 11 by bending the first surface 11 in a direction close to the second surface 21. The second pressing mold 2 includes the second molding portion 22 corresponding to the first molding portion 12. The second molding portion 22 is formed by bending from the second surface 21. For example, the second molding portion 22 is formed by forming a concave shape on the second surface 21 by bending the second surface 21 in a direction away from the first surface 11, or by forming a convex shape on the second surface 21 by bending the second surface 21 in a direction close to the first surface 11.

In particular, there is a space defined between the first surface 11 and the second surface 21 for accommodating a glass product. Specifically, there is a space for molding the glass product defined between the first molding portion 12 on the first surface 11 and the second molding portion 22 on the second surface 21. For example, the glass product may be molded and formed through mutual compression between the first molding portion 12 provided on the first surface 11 and the second molding portion 22 provided on the second surface 21. The first surface 11 defines a cavity region to form the first molding portion 12. That is, the first molding portion 12 is located in the cavity region. The first hydraulic resistance portions 13 are provided outside the cavity region. The second surface 21 defines a cavity region to form the second molding portion 22. That is, the second molding portion 22 is located in the cavity region. The second hydraulic resistance portions 23 are provided outside the cavity region.

The plurality of first hydraulic resistance portions 13 included in the first pressing mold 1 that are spaced apart from each other and the plurality of second hydraulic resistance portions 23 included in the second pressing mold 2 that are spaced apart from each other are described as follows.

The first hydraulic resistance portions 13 are provided close to the outer edge of the first pressing mold 1 and protrude towards the second pressing mold 2 from the first surface 11. In a direction perpendicular to the first surface 11, a junction of each the first hydraulic resistance portions 13 and the first surface 11 has a circular or a fan-ring shape. There are an even number of the first hydraulic resistance portions 13 and the even number of first hydraulic resistance portions 13 are provided around a center of the first surface 11. The second hydraulic resistance portions 23 are provided corresponding to the first hydraulic resistance portions 13. The second hydraulic resistance portions 23 protrude towards the first pressing mold 1 from the second surface 21. The second hydraulic resistance portions 23 are recessed in the second surface 21 in a direction away from the first pressing mold 1. A size of each of the plurality of first hydraulic resistance portions 13 protruding from the first surface 11 is greater than a size of a corresponding second hydraulic resistance portion 23 recessed in the second surface 21. In a direction perpendicular to the second surface 21, a junction of each of the second hydraulic resistance portions 23 and the second surface 21 has a circular or a fan-ring shape. There are an even number of the second hydraulic resistance portions 23 and the even number of the second hydraulic resistance portions 23 are provided around a center of the second surface 21.

In particular, the plurality of first hydraulic resistance portions 13 are provided in the first pressing mold 1. All the plurality of first hydraulic resistance portions 13 are connected with the first surface 11. In the direction perpendicular to the first surface 11, a cross section of the junction of each of the first hydraulic resistance portions 13 and the first surface 11 may have a circular shape or a fan-ring shape. The plurality of first hydraulic resistance portions 13 may refer to an even number of first hydraulic resistance portions 13, such as two first hydraulic resistance portions 13, four first hydraulic resistance portions 13, or six first hydraulic resistance portions 13. The first surface 11 may have a circular shape. A central point of the plurality of first hydraulic resistance portions 13 is the same as a center of the first surface 11. The plurality of first hydraulic resistance portions 13 form a ring close to the outer edge of the first pressing mold 1. Each two adjacent first hydraulic resistance portions 13 have an equal distance therebetween. The second hydraulic resistance portions 23 on the second surface 21 and the first hydraulic resistance portions 13 are in one-to-one correspondence. In the direction perpendicular to the second surface 21, a cross section of a junction of each of the second hydraulic resistance portions 23 and the second surface 21 may have a circular shape or a fan-ring shape. The number of the second hydraulic resistance portions 23 may be the same as the number of the first hydraulic resistance portions 13. The second surface 21 may be a circle. A central point of the plurality of second hydraulic resistance portions 23 is the same as a center of the second surface 21. The plurality of second hydraulic resistance portions 23 form a ring close to the outer edge of the second pressing mold 2. Each two adjacent second hydraulic resistance portions 23 have an equal distance therebetween. Therefore, during manufacturing of the lenses, the peripheral molding pressure of the mold can be increased through the plurality of first hydraulic resistance portions 13 provided close to the outer edge of the first pressing mold 1 and the second hydraulic resistance portions 23 provided on the second surface 21 and respectively corresponding to the first hydraulic resistance portions 13.

To specifically describe configuration of the first hydraulic resistance portions 13 and the second hydraulic resistance portions 23, following implementations are provided. In a first implementation, the first hydraulic resistance portions 13 protrude towards the second pressing mold 2 from the first surface 11, and the second hydraulic resistance portions 23 are substantially flush with the second surface 21. In a second implementation, the first hydraulic resistance portions 13 protrude towards the second pressing mold 2 from the first surface 11, and the second hydraulic resistance portions 23 protrude towards the first pressing mold 1 from the second surface 21. In a third implementation, the first hydraulic resistance portions 13 protrude toward the second pressing mold 2 from the first surface 11, the second hydraulic resistance portions 23 are recessed in the second surface 21 in a direction away from the first pressing mold 1, and a size of each of the first hydraulic resistance portions 13 protruded is greater than a size of a corresponding second hydraulic resistance portion 23 recessed. After the first molding portion 12 and the second molding portion 12 get close to each other, molding pressures inside and outside the glass product between the first surface 11 and the second surface 21 are balanced through the plurality of first hydraulic resistance portions 13 and the plurality of second hydraulic resistance portions 23, which is advantageous for improving yield of products.

In the mold for molding a glass product, the first surface 11 is located on the side of the first pressing mold 1 close to the second pressing mold 2 and the second surface 21 is located on the side of the second pressing mold 2 close to the first pressing mold 1. The first molding portion 12 for molding the glass product in the first pressing mold 1 is formed by bending from the first surface 11. The second molding portion 22 in the second pressing mold 2 corresponds to the first molding portion 12. The second molding portion 22 is formed by bending from the second surface 21. The plurality of first hydraulic resistance portions 13 are provided in the first pressing mold 1 and spaced apart from each other. The first hydraulic resistance portions 13 are close to the outer edge of the first pressing mold 1, and protrude towards the second pressing mold 2 from the first surface 11. In this way, by providing the plurality of first hydraulic resistance portions 13 outside the cavity regions of the first molding portion 12 and the second molding portion 22, a wafer may be prevented from flowing toward external directions of the cavity regions, so as to balance molding pressures inside and outside the cavity regions. Therefore, molding pressures outside the cavity regions during manufacturing of lenses can be increased, thereby increasing a peripheral molding pressure of the mold. As such, molding pressures inside and outside the cavity region are balanced, which is advantageous for improving yield of products. Therefore, technical effects of increasing a molding pressure outside the cavity region, balance of molding pressures inside and outside the cavity region, and improving yield of the products can be achieved.

It shall be noted that the above implementations are only for describing rather than limiting the technical solutions in the disclosure. Although the disclosure is specifically described with reference to examples, those of ordinary skilled shall understand that the technical solution in the disclosure may be amended or equivalently substituted without going beyond the spirit and scope of the technical solution in the disclosure, but the technical solution in the disclosure shall be covered within the scope of the claims in the disclosure.

What is claimed is:

1. A mold for molding a glass product, comprising a first pressing mold having a first surface and a second pressing mold having a second surface, the first surface being located on a side of the first pressing mold close to the second pressing mold, and the second surface being located on a side of the second pressing mold close to the first pressing mold, wherein
the first pressing mold comprises a first molding portion for molding the glass product, and the first molding portion is formed by bending from the first surface;
the second pressing mold comprises a second molding portion corresponding to the first molding portion, and the second molding portion is formed by bending from the second surface; and
the first pressing mold further comprises a plurality of first hydraulic resistance portions spaced apart from each other, the plurality of first hydraulic resistance portions are close to an outer edge of the first pressing mold, and the plurality of first hydraulic resistance portions protrude towards the second pressing mold from the first surface.

2. The mold according to claim 1, wherein the second pressing mold further comprises a plurality of second hydraulic resistance portions spaced apart from each other, and the second hydraulic resistance portions are provided corresponding to the plurality of first hydraulic resistance portions.

3. The mold according to claim 2, wherein the plurality of second hydraulic resistance portions protrude towards the first pressing mold from the second surface.

4. The mold according to claim 2, wherein the plurality of second hydraulic resistance portions are recessed in the second surface in a direction away from the first pressing mold, and a size of each of the plurality of first hydraulic resistance portions protruding from the first surface is greater than a size of a corresponding second hydraulic resistance portion of the plurality of second hydraulic resistance portions recessed in the second surface.

5. The mold according to claim 1, wherein in a direction perpendicular to the first surface, a junction of each of the plurality of first hydraulic resistance portions and the first surface has a circular shape or a fan-ring shape.

6. The mold according to claim 5, wherein the plurality of first hydraulic resistance portions are configured as an even number of first hydraulic resistance portions, and the even number of first hydraulic resistance portions are provided around a center of the first surface.

7. The mold according to claim 3, wherein in a direction perpendicular to the second surface, a junction of each of the plurality of second hydraulic resistance portions and the second surface has a circular shape or a fan-ring shape.

8. The mold according to claim 7, wherein the plurality of second hydraulic resistance portions are configured as an even number of second hydraulic resistance portions, and the even number of second hydraulic resistance portions are provided around a center of the second surface.

9. The mold according to claim 4, wherein in a direction perpendicular to the second surface, a junction of each of the plurality of second hydraulic resistance portions and the second surface has a circular shape or a fan-ring shape.

10. The mold according to claim 9, wherein the plurality of second hydraulic resistance portions are configured as an even number of second hydraulic resistance portions, and the even number of second hydraulic resistance portions are provided around a center of the second surface.

11. The mold according to claim 2, wherein a number of the plurality of first hydraulic resistance portions is the same as a number of the plurality of second hydraulic resistance portions.

12. The mold according to claim 2, wherein each two adjacent second hydraulic resistance portions of the plurality of second hydraulic resistance portions have an equal distance therebetween.

13. The mold according to claim 2, wherein the second hydraulic resistance portions are substantially flush with the second surface.

14. The mold according to claim 2, wherein a central point of the plurality of second hydraulic resistance portions is the same as a center of the second surface.

15. The mold according to claim 1, wherein a central point of the plurality of first hydraulic resistance portions is the same as a center of the first surface.

16. The mold according to claim 1, wherein each two adjacent first hydraulic resistance portions have an equal distance therebetween.
